(19) United States
(12) Patent Application Publication
(10) Pub. No.: US 2015/0258926 A1
(43) Pub. Date: Sep. 17, 2015

(54) APPARATUS FOR DISTRIBUTING CONSTRUCTION MATERIALS

(71) Applicant: Wick Construction, LLC, Warsaw, NY (US)

(72) Inventor: Marcel Wick, Warsaw, NY (US)

(73) Assignee: Wick Construction, LLC, Warsaw, NY (US)

(21) Appl. No.: 14/204,673

(22) Filed: Mar. 11, 2014

(51) Int. Cl. B60P 1/42; A01G 13/00; B60P 1/36; E01C 19/20

(52) U.S. Cl. CPC B60P 1/42; E01C 19/20; A01G 13/0262; B60P 1/36

(57) ABSTRACT

An apparatus for distributing construction material, including a bucket having a front wall, a rear wall, a left side wall, a right side wall, a bottom, an aperture arranged proximate the front wall, and an auger arranged within the bucket between the left side wall and the right side wall, a conveyor positioned below the bucket, the conveyor having a first end and a second end, the first end proximate the aperture in the bucket and operatively arranged to receive materials from the bucket and direct the materials toward the second end, and a front end loader operatively arranged to support and control the bucket and conveyor.

### FIELD OF THE INVENTION

The present invention relates generally to construction services and equipment and, more specifically, to an apparatus for moving and distributing concrete, sand, gravel, mulch, or the like.

### BACKGROUND OF THE INVENTION

Wheelbarrows are simple tools used to carry small loads which typically include an open receptacle supported by one or two wheels at the front and two legs and handles at the rear. To use a wheelbarrow, a user fills the receptacle with some construction material and, to move the wheelbarrow, the user lifts the two legs at the rear using the handles so that the weight of the wheelbarrow is entirely on the one or two wheels at the front. The user can move the wheelbarrow in a desired direction.

Wheelbarrows can be used to lay concrete, sand, gravel, mulch, or other similar construction materials. However, wheelbarrows are designed to be wheeled by hand; thus, wheelbarrows have limited capacity. Wheeling and positioning wheelbarrows proximate a desired destination can be labor intensive and time consuming. Additionally, the task of transferring construction material from the wheelbarrow to a specific location can be prone to human error. For example, while scooping, lifting and moving construction material, a user can inadvertently misplace some construction material. Wheelbarrows are also limited in capacity and difficult to move uphill.

Trucks or cranes can be used to spread a larger amount of construction material. However, trucks and cranes can be difficult to maneuver; thus, laying construction material accurately can be challenging. Additionally, due to the sheer size of trucks and cranes they are often too bulky to access hard to reach areas. Furthermore, the use of trucks or cranes can be expensive and/or dangerous to others nearby.

Others have attempted to make easily maneuverable mechanical spreaders to address these problems. U.S. Pat. No. 5,848,871 (Theissen) describes a metering trough bucket having a flexible bladed auger, which is hydraulically driven in conjunction with a loader. The bucket disclosed is used for moving and accurately placing material, such as concrete. The bucket disclosed aims to provide a labor saving alternative to transporting and pouring concrete with a wheelbarrow. The bucket includes an elongate feed trough having two opposite end portions, an elongate auger having flexible blades positioned in and extending along a bottom portion of the trough, and a discharge sleeve positioned in one end portion. Additionally, this reference describes a cover that prevents material from escaping while the material is being transported. However, the device of the Theissen patent fails to disclose an apparatus having an output arranged orthogonally to the axis of the auger. Additionally, the device of the Theissen patent fails to provide a means for transferring the material in the bucket to some remote location such as, the top of a hillside.

U.S. Pat. No. 7,510,365 (Babiarz) describes a bulk materials bagger and method. The apparatus and method are used in the bagging of bulk products, such as sand, salt, grain, and feed. The apparatus is attachable to a front end loader. The apparatus includes a bucket and an auger mounted in the bucket. The auger forces material out an opening arranged in the side of the bucket. A container is placed adjacent to the opening in the bucket to be filled with material. Additionally, this reference describes a chute having an attachable sleeve to direct a flow of material. However, like the Theissen patent, the Babiarz patent fails to disclose an apparatus having an output arranged orthogonally to the axis of the auger. Plus, the Babiarz patent fails to disclose a means for transferring the material in the bucket to some remote location such as, a crevice or the top of a hillside.

Therefore, there has been a long-felt need for an apparatus for distributing a relatively large amount of construction materials that is easily maneuverable.

Further, there has been a long-felt need for an apparatus for distributing construction materials that includes a bi-directional auger and an output arranged orthogonally to the axis of the auger.

Finally, there has been a long-felt need for an apparatus for distributing construction materials that is efficient and accurate.

### BRIEF SUMMARY OF THE INVENTION

The present invention is an apparatus for distributing construction material, including a bucket having a front wall, a rear wall, a left side wall, a right side wall, a bottom, an aperture arranged proximate the front wall, and an auger arranged within the bucket between the left side wall and the right side wall, a conveyor positioned below the bucket, the conveyor having a first end and a second end, the first end proximate the aperture in the bucket and operatively arranged to receive materials from the bucket and direct the materials toward the second end, and a front end loader operatively arranged to support and control the bucket and conveyor.

The invention also includes an apparatus for distributing construction material, including a hydraulically driven control box, a first motor connected to the control box, a bucket including a bi-directional auger and an aperture, the bucket driven by the first motor and the bi-directional auger operatively arranged to move a material from within the bucket, a second motor connected to the control box, and a conveyor driven by the second motor, where the conveyor is operatively arranged to receive the material from the bucket through the aperture.

The invention further includes an apparatus for distributing construction material including a bucket having a front, a rear, a first side connecting the front and rear of the bucket, a second side opposite the first side and connecting the front and rear of the bucket, a bottom, and an aperture, a hydraulically driven auger arranged within the bucket extending between the first and second sides, the auger having a first blade portion operatively arranged to move material from the first side to the aperture and a second blade portion operatively arranged to move material from the second side to the aperture. The first and second blade portions are co-linear.

A general object of the invention is to provide an easily maneuverable apparatus for distributing a relatively large amount of construction material.

Another object of the invention is to provide an apparatus including a bi-directional auger for distributing and placing construction material.

Yet another object of the invention is to provide an efficient and accurate apparatus for distributing construction material.

Still another object of the invention is to provide an apparatus including a bi-directional auger and an output arranged orthogonally to the axis of the auger for distributing and placing construction material.

A further object of the invention is to provide an apparatus for distributing and placing construction material that can easily distribute material to hard-to-reach locations.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying figures, in which:

FIG. 1 is a perspective view of the apparatus of the invention;

FIG. 2 is a view of the apparatus shown in FIG. 1 from the perspective of an individual operating the apparatus in a front end loader;

FIG. 3 is a detailed view of the inside of the bucket of the apparatus shown in FIGS. 1 and 2;

FIG. 4 is a detailed view of a portion of the apparatus on the actuator side shown not in use;

FIG. 5 is a detailed view of the portion of the apparatus shown in FIG. 4 except shown in use;

FIG. 6 is a detailed view of a portion of the apparatus on the motor side;

FIG. 7 is a view of the apparatus shown in FIG. 2 except in use; and,

FIG. 8 is a perspective view of the apparatus shown in FIG. 1 except in use.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described. In the description below, the term “construction materials” is intended to include concrete, cement, slurry, sand, gravel, stones, mulch, or the like.

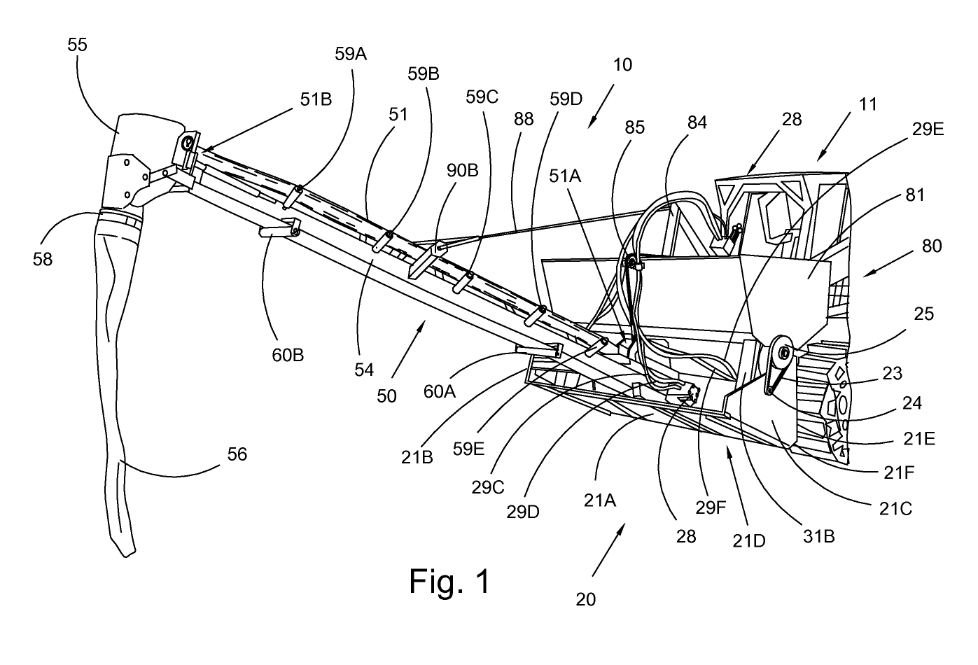

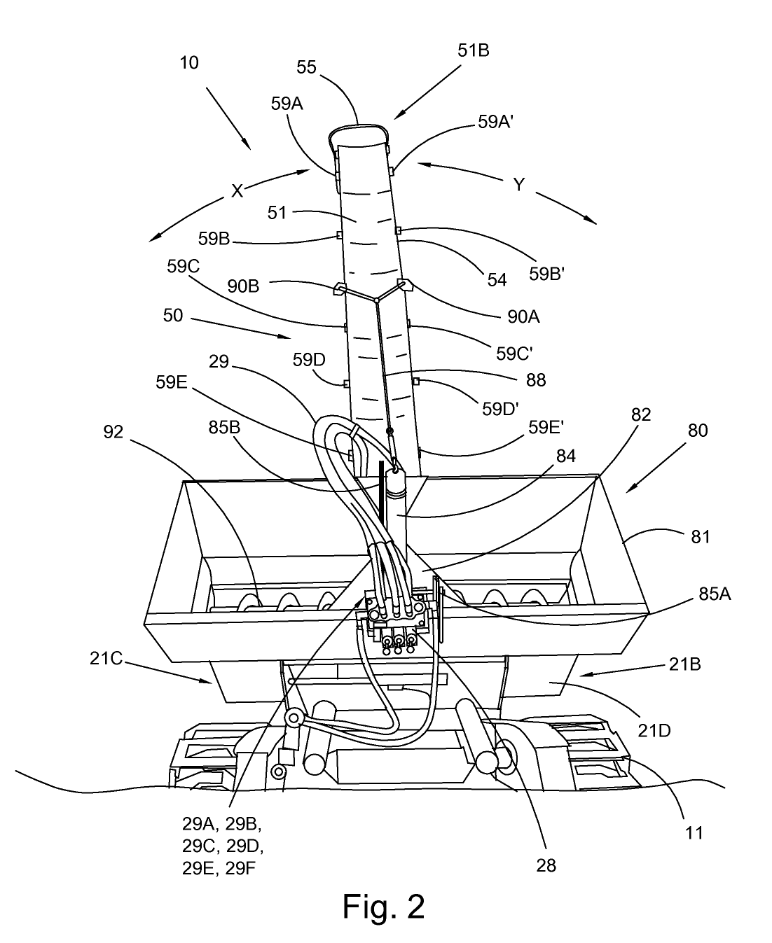

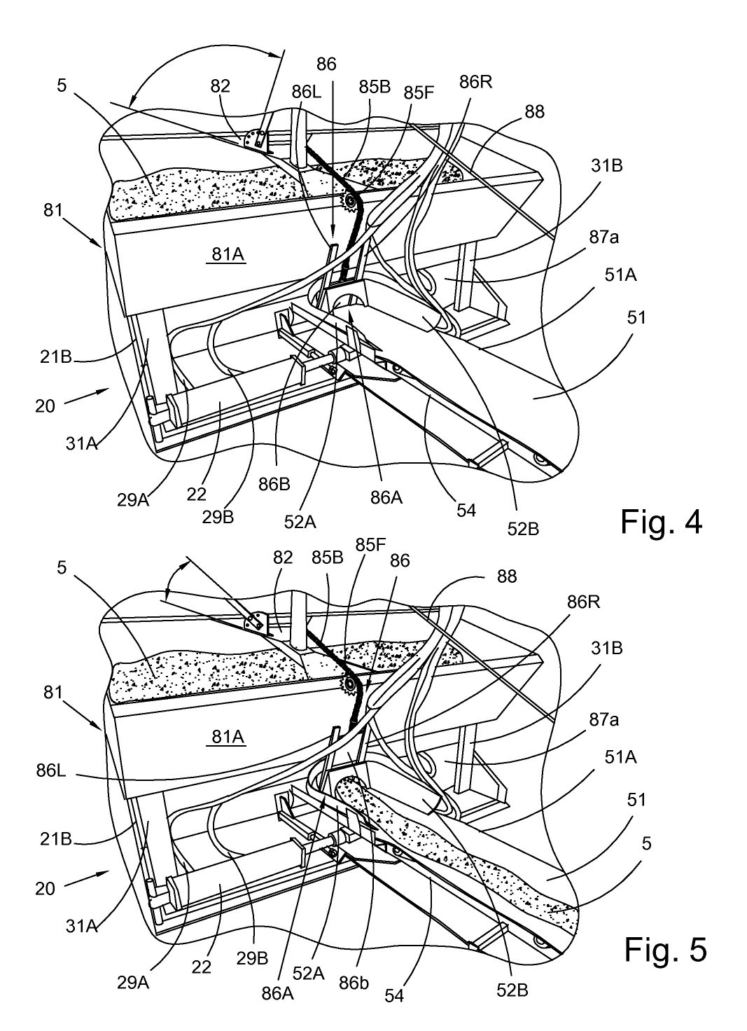

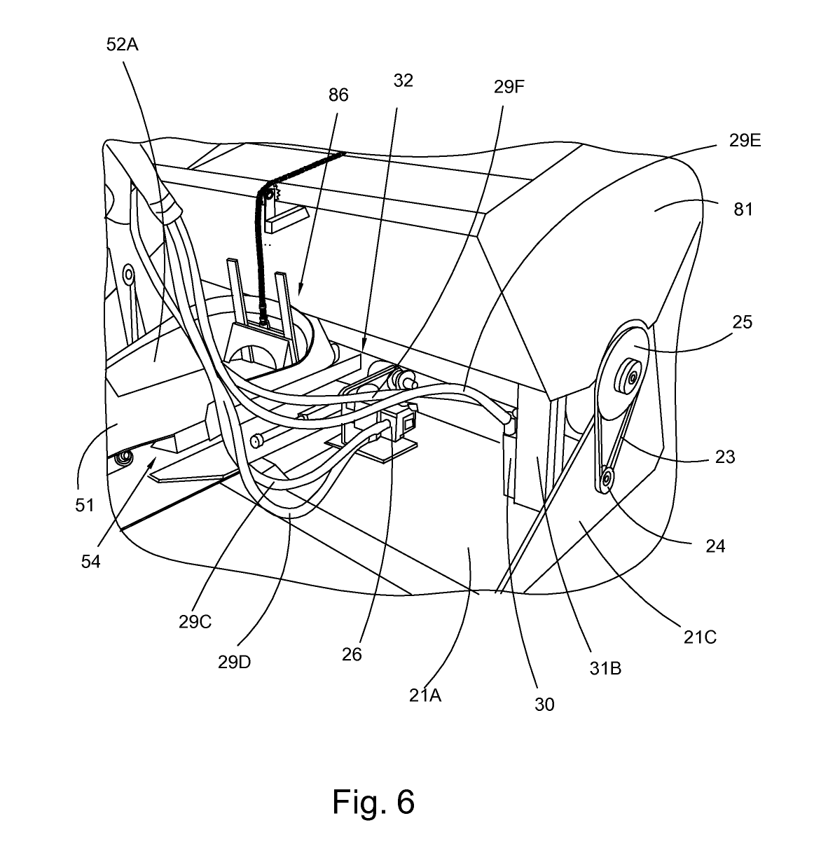

Adverting now to the Figures, FIG. 1 is a perspective view of apparatus 10. Apparatus 10 broadly includes front end loader 11, housing 20, hydraulic control box 28, conveyor assembly 50, and bucket assembly 80. Housing 20 is connected to front end loader 11 by means of a quick release mounting system, for example, a mounting system sold under the trademark Bob-Tach®, available from the Bobcat Company located at 250 East Beaton Drive, West Fargo, N. Dak. 58078-6000. Housing 20 comprises base 21A, side 21B, side 21C and rear 21D. Side 21B is opposite side 21C and base 21A extends between the bottom edges of side 21B and side 21C. Proximate front end loader 11, sides 21B and side 21C each have substantially upright edge 21E which is arranged at an angle in relation to base 21A. In a preferred embodiment, the angle is less than 90 degrees. However, it should be appreciated that any angle is suitable so that housing 20 is arranged to support conveyor assembly 50 and direct conveyor assembly 50 in a slightly upward direction. In a preferred embodiment, apparatus 10 can raise construction materials approximately 25 feet. In an example embodiment, sides 21B and side 21C each have angled edge 21F connecting substantially upright edge 21E and base 21A. Rear 21D of housing 20 extends between upright and angled edges 21E and 21F of side 21B and side 21C proximate front end loader 11. Opposite front end loader 11, housing 20 is open between side 21B and side 21C. Drive gear 24 is operatively arranged on side 21C connected to bucket hydraulic motor 30 (shown in FIG. 6) and connected to bucket gear 25 via bucket drive train 23. Drive gear 24, bucket drive train 23, and bucket gear 25 transmit rotation to auger 92 (shown in FIG. 2) within bucket 81. Bucket 81 of bucket assembly 80 is welded to housing 20 and supported by bucket support 31B, which is mounted to base 21A of housing 20. A second bucket support 31A opposite bucket support 31B (better shown in FIGS. 4 and 5) is mounted to base 21A of housing 20 to support bucket 81. Housing 20 is preferably made of steel, however any suitable material which is lightweight and sturdy can be used. Bucket drive train 23 is preferably made of a steel chain, however any suitable material could be used. Drive gear 24 is preferably made of steel, however any suitable material could be used. Bucket gear 25 is preferably made of steel, however any suitable material could be used.

Conveyor assembly 50 broadly comprises conveyor belt 51, conveyor support 54, conveyor roller 60A, and conveyor roller 60B. Conveyor assembly 50 further includes first end 51A proximate housing 20 and second end 51B opposite housing 20. Conveyor belt 51 extends between first end 51A and second end 51B substantially linearly. Conveyor hydraulic motor 26 (shown in FIG. 6) is connected to conveyor assembly 50 within housing 20. Conveyor hydraulic motor 26 drives conveyor assembly 50 via hydraulic control box 28. In an example embodiment, conveyor assembly 50 includes funnel 55, directional chute 56, and nozzle 58 to direct and place material from conveyor belt 51 to a particular area. Funnel 55 is preferably made of steel or plastic, however any suitable material could be used. Directional chute 56 is preferably made of a flexible material, for example, rubber, plastic, or fabric. Nozzle 58 is preferably made of steel or plastic, however any suitable material could be used.

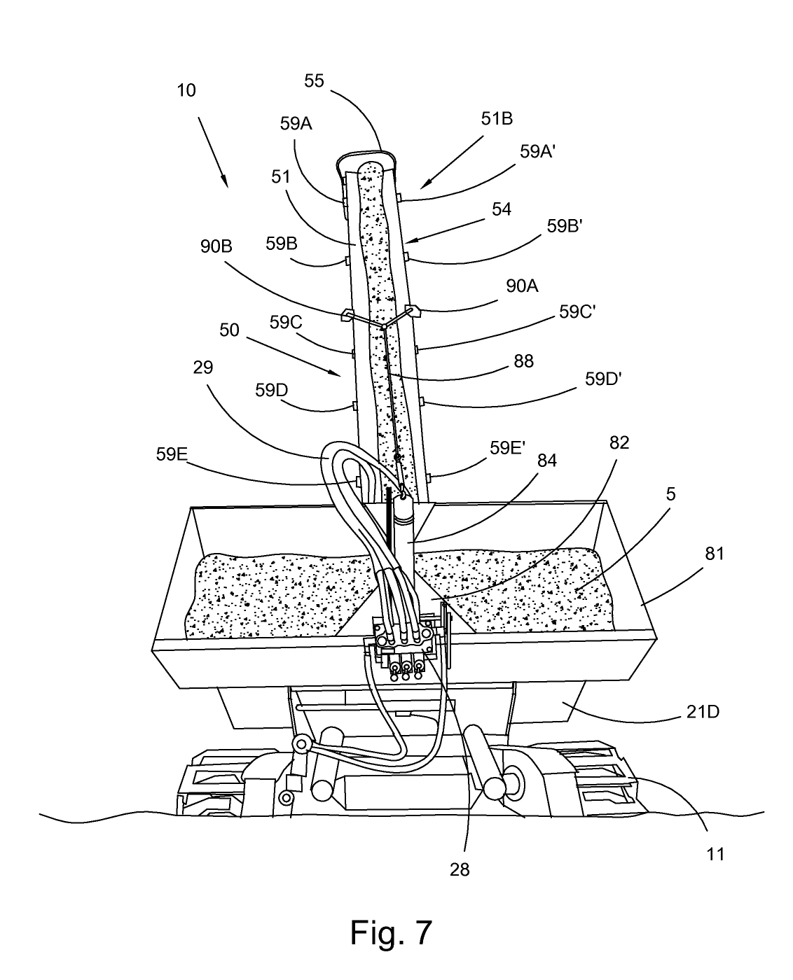

Conveyor support 54 supports conveyor belt 51 of conveyor assembly 50. Conveyor support 54 is mounted to housing 20 proximate first end 51A of conveyor assembly 50, particularly between side 21A and side 21B. Conveyor belt 51 has a width that is larger than the width of conveyor support 54. Conveyor support 54 includes plurality of supports 59A, 59A′, 59B, 59B′, 59C, 59C′, 59D, 59D′, 59E, and 59E′ which protrude outwardly from the sides of conveyor support 54 in a slightly upward direction. In a preferred embodiment, As shown in FIG. 1, the outside longitudinal edge of conveyor belt 51 rests atop plurality of supports 59A, 59B, 59C, 59D, and 59E. Since plurality of supports 59A, 59B, 59C, 59D, and 59E are tilted upwardly from conveyor support 54, the outside longitudinal edges of conveyor belt 51 are also titled upwardly such that as conveyor belt 51 transports material 5 (shown in FIG. 7) from first end 51A to second end 51B, material 5 does not fall off the sides of conveyor belt 51. In an example embodiment, conveyor support 54 is mounted to base 21A of housing 20 via a pivot or bearing, for example. Conveyor support 54 is mounted to housing 20 such that conveyor assembly 50 can pivot via actuator 22 (described in further detail below). Conveyor belt 51 extends the length of conveyor support 54 from first end 51A to second end 51B. Conveyor belt 51 hinges off of one 2.5 inch center pivot point. Conveyor belt 51 engages conveyor hydraulic motor 26 (shown in FIG. 6) such that rotation of conveyor hydraulic motor 26 transmits rotation to conveyor belt 51. Conveyor belt 51 is preferably made of rubber or canvas, however any suitable material could be used. Conveyor support 54 is preferably made of steel, however any suitable material could be used.

Conveyor rollers 60A and 60B are arranged beneath conveyor support 54 to keep tension in conveyor belt 51 and direct conveyor belt 51 as it moves from second end 51B to first end 51A. Funnel 55 is removably arranged on conveyor support 54 proximate second end 51B. Funnel 55, directional chute 56 and nozzle 58 are removable by means of latches on either side. When the latches are undone for removal, funnel 55 can be swiveled approximately 90 degrees; thereafter, funnel 55 can be disengaged. Funnel 55 is arranged to receive material transported along conveyor belt 51. Nozzle 58 is operatively arranged under funnel 55 to connect funnel 55 and directional chute 56. Directional chute 56 is made of a lightweight and flexible material, such as canvas, to allow a user to easily move and direct chute 56. When directional chute 56 is engaged with conveyor assembly 50, material 5 (shown in FIG. 5) is distributed wherever directional chute 56 is directed. Conveyor rollers 60A and 60B are preferably made of rubber or plastic, however any suitable material could be used. In a preferred embodiment, conveyor 51 is approximately 14 to 15 feet.

Support cable 88 and cable support 84 help maintain the position of conveyor assembly 50. Support cable 88 is connected to conveyor support 54 via cable mount 90B and cable mount 90A. Cable mount 90A is opposite cable mount 90B. The portion of support cable 88 proximate cable mounts 90A and 90B is “V” shaped to engage the outside edges of conveyor support 54 beyond the width of conveyor belt 51. On the other end of support cable 88, support cable 88 is mounted to cable support 84, which is arranged on transverse bucket support 82 (shown in FIG. 2). Transverse bucket support 82 is mounted to bucket 81 via welding, for example. Bucket 81 is preferably made of steel, however any suitable material can be used. In a preferred embodiment, bucket 81 is approximately 79 inches wide. Transverse bucket support 82, cable support 84, support cable 88, cable mounts 90A and 90B are preferably made of steel, however any suitable material can be used.

FIG. 2 is a view of apparatus 10 from the perspective of an individual operating apparatus 10 via front end loader 11. Conveyor assembly 50 is shown extending outwardly from beneath bucket assembly 80. The “V” shaped portion of support cable 88 is shown. In an example embodiment, support cable 88 includes two cables both connected to cable support 84 from cable mounts 90A and 90B and both cables are joined together with a fastening means proximate conveyor belt 51. Conveyor assembly 50 is pivotable via actuator 22 (shown in FIGS. 4 and 5). In an example embodiment, conveyor assembly 50 is rotatable to the right along arc Y approximately seven feet and to the left along arc X approximately eight feet. It should be appreciated that these distances can change due to alterations within the mounting of conveyor support 54 and the safety factor of front end loader 11. Hydraulic control box 28 is mounted atop bucket 81 such that a user sitting within front end loader 11 can easily control apparatus 10.

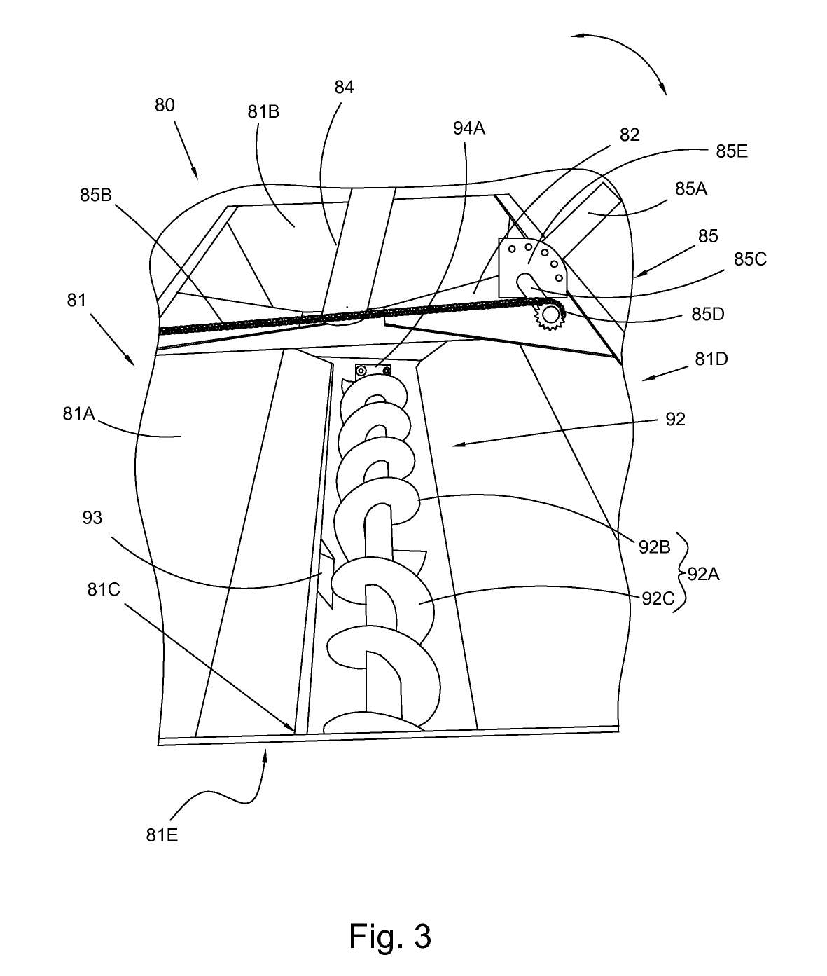

Hydraulic cables 29A, 29B, 29C, 29D, 29E, and 29F within hydraulic cable wrap 29 extend from hydraulic control box 28 to power motors 26 and 30 of apparatus 10. Hydraulic cable wrap 29 prevents the cables from interfering with the operation of apparatus 10. Cable mount 90A, cable mount 90B, cable support 84, transverse bucket support 82, and support cable 88 are arranged such that they do not interfere with the rotation of conveyor support 54. Additionally, cable mount 90A, cable mount 90B, cable support 84, transverse bucket support 82, and support cable 88 are also arranged to distribute the load along conveyor belt 51. Auger 92 is operatively arranged within bucket 81 to move material from the sides of bucket 81 towards the middle of bucket 81 where it can be distributed onto conveyer belt 51 through aperture 93 (shown in FIG. 3). Aperture 93 is positioned orthogonally with respect to the sides of bucket 81. Hydraulic cables 29A, 29B, 29C, 29D, 29E, and 29F are preferably made of steel hose and covered in rubber. Hydraulic cable wraps 29 are preferably made of a fibrous material, for example, plastic or fabric. Auger 92 is preferably made of steel, however any suitable material can be used.

Mechanism 85 is operatively arranged to open and shut door 86 arranged proximate aperture 93 (shown in FIGS. 4 and 5). As shown in FIGS. 3, 4 and 5, mechanism 85 includes lever 85A pivotally mounted to bucket 81 via mount 85E proximate hydraulic control box 28 via welding, for example. Chain 85B is connected to lever 85A via bar 85C and gear 85D. Lever 85A is secured to bar 85C via a screw means or welding and lever 85A is rotatable around an aperture within mount 85E of mechanism 85. When lever 85A is pulled downward and toward a user sitting within front end loader 11, chain 85B is pulled toward the user sitting within front end loader 11 (as shown in FIG. 3 gear 85D rotates clockwise) and door 86 opens. In contrast, when lever 85A is pushed upward and away from the user sitting within front end loader 11, chain 85B is pushed away from the user sitting within front end loader 11 (as shown in FIG. 3 gear 85D rotates counter-clockwise) and door 86 closes.

A detailed view of the inside of bucket assembly 80 of apparatus 10 is also shown in FIG. 3. Bucket assembly 80 comprises bucket 81, transverse bucket support 82, cable support 84, auger 92, aperture 93, auger mount 94A, and auger mount 94B opposite auger mount 94A. Auger mounts 94A and 94B are preferably steel bearings. Bucket 81 comprises front 81A, side 81B, side 81C, rear 81D, and bottom 81E. The top of bucket 81 is predominantly open except for transverse bucket support 82 supporting cable support 84. The ends of auger 92 are mounted to sides 81B and 81C, respectively, of bucket 81 via auger mount 94A and auger mount 94B, respectively. Auger mount 94A and auger mount 94B are arranged to allow for free rotation of auger 92 which receives power input from bucket gear 25 (shown in FIG. 1). Auger 92 extends along bottom 81E of bucket 81. Auger 92 includes blade 92A, which is operatively arranged to push material 5 (shown in FIG. 5) towards and through aperture 93. In other words, blade 92A includes first portion 92B, which pushes material 5 from side 81B to aperture 93 and, blade 92A includes second portion 92C, which pushes material 5 from side 81C to aperture 93. Blade portions 92B and 92C are co-linear and preferably made of a single piece of steel. In an example embodiment, aperture 93 is arranged substantially halfway between sides 81B and 81C. Auger 92 can run in reverse to mix a load. Additionally, it should be appreciated that, in a preferred embodiment, aperture 93 is approximately 8 inches by 8 inches.

FIG. 4 is a detailed view of a portion of apparatus 10 showing actuator 22. Bucket 81 contains construction material 5. Actuator 22 is mounted to side 21B of housing 20. In an example embodiment, actuator 22 is mounted with a pivot joint to both side 21B and conveyor support 54. It should be appreciated that the location of actuator 22 can be altered to increase performance of apparatus 10. Actuator 22 is powered via hydraulic fluid from hydraulic cable 29A and hydraulic cable 29B. Bucket support 31A, bucket support 31B, and transverse bucket support 82 provide support for bucket 81. Since bucket 81 can hold a variety of heavy material, such support is necessary. Bucket supports 31A and 31B are preferably made of steel, however any suitable material can be used. When apparatus 10 is not in operation, door 86 is in the closed position to prevent material 5 from escaping through aperture 93. Door 86 is slidable proximate aperture 93. Chain 85B is rotatable about gear 85F which is mounted to front 81A of bucket 81.

Door 86 comprises base portion 86A, guides 86L and 86R, and slidable member 86B. Base portion 86A is fixedly secured to conveyor means 50 proximate aperture 93 of bucket 81 via welding, for example. Base portion 86A provides support for guides 86L, 86R and slidable member 86B. Base portion 86A is shaped substantially like a triangular prism except it includes an opening to allow for material to flow through. Guides 86L and 86R are fixedly secured to base portion 86A and emanate upwardly from base portion 86A and outwardly from bucket 81 at an angle. Guide 86L mirrors guide 86R on opposite sides of base portion 86A. Slidable member 86B is slidably arranged between guides 86L and 86R. Guides 86L and 86R are substantially “L” shaped to cradle slidable member 86B.

The portion of apparatus 10 shown in FIG. 4 is shown in FIG. 5 except apparatus 10 is in operation and material 5 is flowing from bucket 81 through aperture 93 past door 86 and onto conveyor belt 51. Base portion 86A helps provide guidance for material 5 as it exits bucket 81 onto conveyor belt 51. In an example embodiment, conveyor assembly 50 includes funnel 52A and funnel 52B to direct material from aperture 93 of bucket 81 along conveyor belt 51. Funnels 52A and 52B are preferably made of steel or plastic. Additionally, as spreading material 5 is deposited onto conveyor belt 51, funnel 52A and funnel 52B are arranged on conveyor support 54 to prevent material 5 from falling off conveyor belt 51. Bucket funnel 52A and bucket funnel 52B are mounted proximate the sides of door 86.

FIG. 6 is a detailed view of the portion of apparatus 10 shown in FIG. 4 except taken from the side showing motors 26 and 30. Conveyor hydraulic motor 26 is mounted to conveyor support 54 and, preferably, is not mounted to base 21A. Since conveyor hydraulic motor 26 is coupled to conveyor support 54, conveyor assembly 50 can pivot along arcs X and Y. To rotate conveyor belt 51, hydraulic fluid is pumped by a hydraulic pump, located within front end loader 11, through hydraulic control box 28 and through hydraulic cable 29C and hydraulic cable 29D to conveyor hydraulic motor 26. Drive chain 32 transfers the torque generated in conveyor hydraulic motor 26. Drive chain 32 is operatively arranged to receive torque from conveyor hydraulic motor 26 and rotate conveyor belt 51. Drive chain 32 is preferably a steel chain, however any suitable alternative can be used.

Hydraulic fluid is also pumped from hydraulic control box 28 through hydraulic cables 29E and 29F to bucket hydraulic motor 30. Bucket hydraulic motor 30 is operatively arranged to rotate drive gear 24 arranged on side 21C, which in turn, transfers the torque generated through bucket drive train 23 to bucket gear 25. Bucket gear 25 is arranged on bucket 81 in order to engage auger 92 to move material 5 onto conveyor belt 51.

FIG. 7 depicts apparatus 10 as shown in FIG. 2 except in operation. Material 5 travels from bucket 81 and along conveyor assembly 50. Hydraulic control box 28 is arranged to control the flow rate of material 5. The speed of auger 92 and conveyor belt 51 can be independently controlled via hydraulic control box 28. In a preferred embodiment, apparatus 10 is powered by approximately 80 horse power.

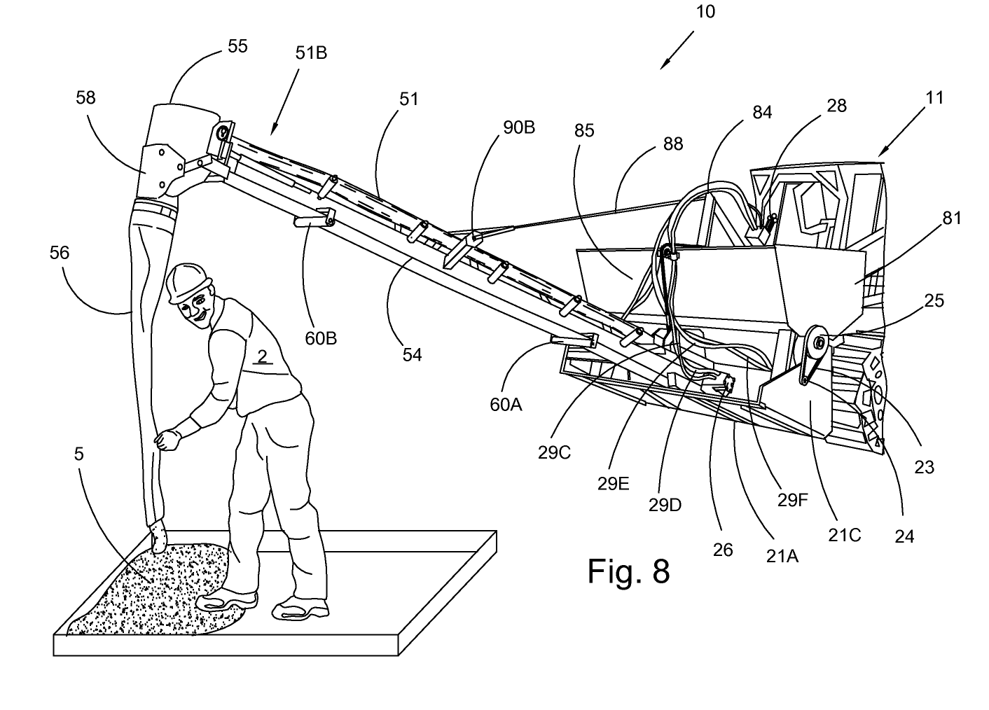

FIG. 8 is a perspective view of apparatus 10 in use. As shown in FIG. 7, material 5 travels from bucket 81 along conveyor belt 51 to second end MB. Material 5 is optionally received by funnel 55 located at second end MB and directed through nozzle 58 into directional chute 56. Person 2 manipulates directional chute 56 in order to direct the direction of material 5. If material 5 is intended to be distributed across a large area, funnel 55, nozzle 58, and directional chute 56 can be removed to allow spreading material 5 to be distributed directly from conveyor belt 51. Hydraulic control box 28 controls the flow of hydraulic fluid through hydraulic cables 29C, 29D, 29E, and 29F which control the speed and torque of conveyor hydraulic motor 26 and bucket hydraulic motor 30 (shown in FIG. 6). In a preferred embodiment, apparatus 10 is capable of holding 27 cubic feet of loading and withstanding 3,500 pounds.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMERALS

2 person
5 material
10 apparatus
11 front end loader
20 housing
21A base
21B side
21C side
21D rear
21E upright edge
21F angled edge
22 actuator
23 bucket drive train
24 drive gear
25 bucket gear
26 conveyor hydraulic motor
28 hydraulic control box
29 hydraulic cable wrap
29A hydraulic cable
29B hydraulic cable
29C hydraulic cable
29D hydraulic cable
29E hydraulic cable
29F hydraulic cable
30 bucket hydraulic motor
31A bucket support
31B bucket support
32 drive chain
50 conveyor assembly
51A first end
51B second end
51 conveyor belt
52A funnel
52B funnel
54 conveyor support
55 funnel
56 directional chute
58 nozzle
59A support
59A′ support
59B support
59B′ support
59C support
59C′ support
59D support
59D′ support
59E support
59E′ support
60A conveyor roller
60B conveyor roller
80 bucket assembly
81 bucket
81A front
81B side
81C side
81D rear
81E bottom
82 transverse bucket support
84 cable support
85 mechanism
85A lever
85B chain
85C bar
85D gear
85E mount
85F gear
86 door
86A base portion
86B slidable member
86L guide
86R guide
88 support cable
90A cable mount
90B cable mount
92 auger
92A blade
92B blade portion
92C blade portion
93 aperture
94A auger mount
94B auger mount
X direction
Y direction

What is claimed is:

1. An apparatus for distributing construction material, comprising:
a bucket having a front wall, a rear wall, a left side wall, a right side wall, a bottom, an aperture arranged proximate said front wall, and an auger arranged within said bucket between said left side wall and said right side wall;
a conveyor positioned below said bucket, said conveyor having a first end and a second end, said first end proximate said aperture in said bucket and operatively arranged to receive said materials from said bucket and direct said materials toward said second end; and,
a front end loader operatively arranged to support and control said bucket and conveyor.

2. The apparatus for distributing construction material recited in claim 1, further comprising a housing secured below said bucket.

3. The apparatus for distributing construction material recited in claim 2, wherein said housing includes a motor operatively arranged to drive said auger with said bucket.

4. The apparatus for distributing construction material recited in claim 2, wherein said housing includes a motor operatively arranged to drive said conveyor.

5. The apparatus for distributing construction material recited in claim 1, wherein said aperture is arranged substantially halfway between said left side wall and said right side wall of said bucket.

6. The apparatus for distributing construction material recited in claim 1, further comprising a door slidably arranged proximate said aperture.

7. The apparatus for distributing construction material recited in claim 2, wherein said housing further comprises an actuator operatively arranged to move said conveyor.

8. The apparatus for distributing construction material recited in claim 7, wherein said conveyor is moveable about a pivot point proximate said first end of said conveyor.

9. The apparatus for distributing construction material recited in claim 7, wherein said second end of said conveyor is moveable along an arcuate path in relation to a pivot point proximate said first end of said conveyor.

10. The apparatus for distributing construction material recited in claim 1, further comprising an attachable chute for directing distributed construction materials.

11. An apparatus for distributing construction material, comprising:
a hydraulically driven control box;
a first motor connected to said control box;
a bucket including a bi-directional auger and an aperture, said bucket driven by said first motor and said bi-directional auger operatively arranged to move a material from within said bucket;
a second motor connected to said control box; and,
a conveyor driven by said second motor, where said conveyor is operatively arranged to receive said material from said bucket through said aperture.

12. The apparatus for distributing construction material recited in claim 11, further comprising an actuator connected to said control box.

13. The apparatus for distributing construction material recited in claim 12, wherein said conveyor is actuated by said actuator.

14. The apparatus for distributing construction material recited in claim 11, wherein said bucket comprises a first end, a second end, and a front end proximate said conveyor.

15. The apparatus for distributing construction material recited in claim 14, wherein said aperture is arranged approximately halfway between said first end and said second end and proximate said front end.

16. The apparatus for distributing construction material recited in claim 11, further comprising a door slidably arranged proximate said aperture.

17. The apparatus for distributing construction material recited in claim 11, wherein said conveyor is pivotable.

18. The apparatus for distributing construction material recited in claim 15, wherein said auger includes a first blade portion operatively arranged to move material from said first end to said aperture and a second blade portion operatively arranged to move material from said second end to said aperture.

19. The apparatus for distributing construction material recited in claim 18, wherein said first and second blade portions are co-linear.

20. An apparatus for distributing construction material, comprising:
a bucket having a front, a rear, a first side connecting said front and rear of said bucket, a second side opposite said first side and connecting said front and rear of said bucket, a bottom, and an aperture;
a hydraulically driven auger arranged within said bucket extending between said first and second sides, said auger having:
a first blade portion operatively arranged to move material from said first side to said aperture; and,
a second blade portion operatively arranged to move material from said second side to said aperture;
wherein said first and second blade portions are co-linear.
